(19) United States
(12) Patent Application Publication
(10) Pub. No.: US 2018/0097940 A1
(43) Pub. Date: Apr. 5, 2018

(54) SYSTEM AND METHOD FOR DYNAMIC GENERATION AND OPTIMIZATION OF PROCESS FLOWS FOR A CUSTOMER CONTACT CENTER

(71) Applicant: Genesys Telecommunications Laboratories, Inc., Daly City, CA (US)

(72) Inventors: David Beilis, Toronto (CA); Adrian Lee-Kwen, North York (CA); Michael Orr, Belfast (GB); Herbert Willi Artur Ristock, Walnut Creek, CA (US)

(21) Appl. No.: 15/283,003

(22) Filed: Sep. 30, 2016

(51) Int. Cl. H04M 3/523; G06F 17/27

(52) U.S. Cl. CPC H04M 3/5235; G06F 17/27

(57) ABSTRACT

In a system for dynamically generating an execution flow for a customer contact center, the system includes: a switch; a processor coupled to the switch; and a memory coupled to the processor, wherein the memory stores instructions that, when executed by the processor, cause the processor to: receive customer input related to an ongoing communication session; perform natural language processing on the customer input to identify a plurality of intent parameters including a customer objective; generate an execution flow for achieving the customer objective based on the plurality of intent parameters; and transmit a signal to the switch for routing the ongoing communication session to a contact center resource according to the execution flow.

### FIELD

Aspects of embodiments of the present invention relate to a system and method for dynamic generation and optimization of process flows for a customer contact center.

### BACKGROUND

In order to remain competitive in the modern commerce system, many businesses remain constantly vigilant of evolving consumer demands, and strive to provide customers with the high quality products and services that they desire. To that end, many businesses employ contact centers that include automated systems and representatives of the business to process transactions and/or service the needs of their customers.

In order to improve efficiencies and reduce costs, contact center systems may employ automated systems to handle at least some portion of communication sessions with customers. For example, a contact center system may deploy an interactive voice response (IVR) system to enable the contact center to collect information about a customer and to determine an appropriate routing strategy, communication path, or execution strategy for the customer. Such systems may require a customer to navigate through a series of IVR menu options or an automated self-service portal, which enables the contact center to reduce employee or agent overhead, but may lead to additional effort on the part of customers who must spend time navigating the automated system. Additionally, such systems are typically inflexible and only allow customers to traverse one of a finite number of predetermined communication paths or execution strategies. Furthermore, the possible information that can be provided by a customer at each step in an IVR system may be limited to only a few discrete options, and the customer may lack the ability to indicate a desire to resolve multiple issues in the same communication session. Thus, for various reasons, related art IVR systems may create inherent inefficiencies in terms of customer time. Additionally, related art contact center systems may lead to inefficient use of contact center resources.

The above information discussed in this Background section is only for enhancement of understanding of the background of the described technology and therefore it may contain information that does not constitute prior art that is already known to a person having ordinary skill in the art.

### SUMMARY

Embodiments of the present invention are directed to systems and methods for anticipating and preloading data in a customer contact center.

According to some embodiments of the present invention, in a system for dynamically generating an execution flow for a customer contact center, the system includes: a switch; a processor coupled to the switch; and a memory coupled to the processor, wherein the memory stores instructions that, when executed by the processor, cause the processor to: receive customer input related to an ongoing communication session; perform natural language processing on the customer input to identify a plurality of intent parameters including a customer objective; generate an execution flow for achieving the customer objective based on the plurality of intent parameters; and transmit a signal to the switch for routing the ongoing communication session to a contact center resource according to the execution flow.

According to some example embodiments, the customer objective includes a plurality of customer objectives, and wherein the instructions further cause the processor to identify a plurality of execution steps for each of the plurality of customer objectives.

According to some example embodiments, the instructions further cause the processor to consolidate redundant steps for the plurality of customer objectives to generate consolidated steps.

According to some example embodiments, the instructions further cause the processor to generate the execution flow based on the consolidated steps.

According to some example embodiments, the instructions further cause the processor to identify customer profile data based on the customer input.

According to some example embodiments, the instructions further cause the processor to identify customer interaction history data based on the customer input.

According to some example embodiments, the instructions further cause the processor to optimize the execution flow according to contact center resources.

According to some example embodiments, optimizing the execution flow comprises selecting the execution flow from among a plurality of potential execution flows having a cost that is less than other ones of the potential execution flows.

According to some example embodiments, optimizing the execution flow comprises selecting the execution flow from among a plurality of execution flows based on the execution flow having a number of intermediate operations that is less than that of other ones of the execution flows.

According to some example embodiments, the instructions further cause the processor to: retrieve a domain model graph corresponding to the customer contact center, the domain model graph comprising a plurality of interconnected nodes; match the intent parameters including the customer objective to corresponding ones of the interconnected nodes; and generate the execution flow by selecting a path from among a plurality of potential paths for achieving the customer objective.

According to some example embodiments, the interconnected nodes correspond to intermediate steps for achieving the customer objective and comprise preprogrammed modules for executing the intermediate steps.

According to some example embodiments of the present invention, in a method for dynamically generating an execution flow for a customer contact center, the method includes: receiving, by a processor, customer input related to an ongoing communication session; performing, by the processor, natural language processing on the customer input to identify a plurality of intent parameters including a customer objective; generating, by the processor, an execution flow for achieving the customer objective based on the plurality of intent parameters; and transmitting, by the processor, a signal to a switch for routing the ongoing communication session to a contact center resource according to the execution flow.

According to some example embodiments, the customer objective includes a plurality of customer objectives, and the method further includes identifying, by the processor, a plurality of execution steps for each of the plurality of customer objectives.

According to some example embodiments, the method further includes consolidating, by the processor, redundant steps for the plurality of customer objectives to generate consolidated steps.

According to some example embodiments, the method further includes generating, by the processor, the execution flow based on the consolidated steps.

According to some example embodiments, the method further includes identifying, by the processor, customer interaction history data based on the customer input.

According to some example embodiments, the method further includes optimizing, by the processor, the execution flow according to contact center resources.

According to some example embodiments, optimizing the execution flow includes selecting the execution flow from among a plurality of potential execution flows having a cost that is less than other ones of the potential execution flows.

According to some example embodiments, the method further includes: retrieving, by the processor, a domain model graph corresponding to the customer contact center, the domain model graph comprising a plurality of interconnected nodes; matching, by the processor, the intent parameters including the customer objective to corresponding ones of the interconnected nodes; and generating, by the processor, the execution flow by selecting a path from among a plurality of potential paths for achieving the customer objective.

According to some example embodiments of the present invention, in a system for dynamically generating an execution flow for a customer contact center, the system includes: means for receiving customer input related to an ongoing communication session; means for performing natural language processing on the customer input to identify a plurality of intent parameters including a customer objective; means for generating an execution flow for achieving the customer objective based on the plurality of intent parameters; and means for transmitting a signal to a switch for routing the ongoing communication session to a contact center resource according to the execution flow.

### BRIEF DESCRIPTION OF THE DRAWINGS

A more complete appreciation of the present invention, and many of the attendant features and aspects thereof, will become more readily apparent as the invention becomes better understood by reference to the following detailed description when considered in conjunction with the accompanying drawings in which like reference symbols indicate like components, wherein:

FIG. 1 is a block diagram of a system for anticipating and preloading data and anticipating user interactions in a customer contact center, according to some embodiments of the present invention;

FIG. 2 is a schematic block diagram of an execution strategy server operating as part of the contact center system, according to some embodiments of the present invention;

FIG. 3 is a flow diagram of a process for dynamic generation and optimization of process flows, according to some embodiments of the present invention;

FIGS. 4A and 4B are block diagrams illustrating a process for generating (and/or optimizing) an execution strategy, according to some example embodiments of the present invention.

FIG. 5 is a domain specific language tree illustrating an example use case of a dynamic execution strategy system for a pre-paid service cellular provider operating a contact center system according to some embodiments of the present invention;

FIG. 6 illustrates an example execution plan for a self-provisioning operation as part of a contact center system, according to some example embodiments of the present invention;

FIG. 7 is another example execution plan for handling a bill payment inquiry, according to some example embodiments of the present invention;

FIG. 8 is yet another example execution plan for handling a service upgrade, according to some example embodiments of the present invention;

FIG. 9A illustrates a process for mapping intent parameters to a domain model graph for generating an execution strategy, according to some embodiments of the present invention;

FIG. 9B illustrates an optimized execution strategy generated based on a domain model graph, according to some embodiments of the present invention;

FIG. 10A is a block diagram of a computing device according to an embodiment of the present invention;

FIG. 10B is a block diagram of a computing device according to an embodiment of the present invention;

FIG. 10C is a block diagram of a computing device according to an embodiment of the present invention;

FIG. 10D is a block diagram of a computing device according to an embodiment of the present invention; and

FIG. 10E is a block diagram of a network environment including several computing devices according to an embodiment of the present invention.

### DETAILED DESCRIPTION

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Generally, modern contact centers are staffed with agents or employees who serve as an interface between an organization, such as a company, and outside entities, such as customers. For example, human sales agents at contact centers may assist customers in making purchasing decisions and may receive purchase orders from those customers. Similarly, human support agents at contact centers may assist customers in solving problems with products or services provided by the organization. Interactions between contact center agents and outside entities (customers) may be conducted by speech voice (e.g., telephone calls or voice over IP or VoIP calls), video (e.g., video conferencing), text (e.g., emails or text chat), or through other media.

In order to remain competitive, however, businesses constantly strive to provide high quality service to customers while keeping prices low. Employing and training dozens, hundreds, or even thousands of live human agents to handle interactions with customers adds additional overhead costs to the business, which may eventually be passed on to consumers in the form of higher prices for the products or services sold by the business.

Accordingly, embodiments of the present invention are directed to improving efficiency and productivity during interactions, while simultaneously improving the customer experience. Embodiments of the present invention are also directed to providing efficiencies and speed for the various computer resources invoked during such interactions. For example, embodiments of the present invention provide systems and methods for dynamic generation and optimization of process flows or execution strategies for a customer contact center. According to some embodiments, such dynamically generated and optimized process flows or execution strategies may be generated based on arbitrary or natural language customer input of requests for handling one or more specific problem domains.

In the various embodiments, the terms interaction and communication are used generally to refer to any real-time and non-real time interaction that uses any communication channel including, without limitation telephony calls (PSTN or VoIP calls), emails, vmails (voice mail through email), video, chat, screen-sharing, text messages, social media messages, web real-time communication (e.g. WebRTC calls), and the like.

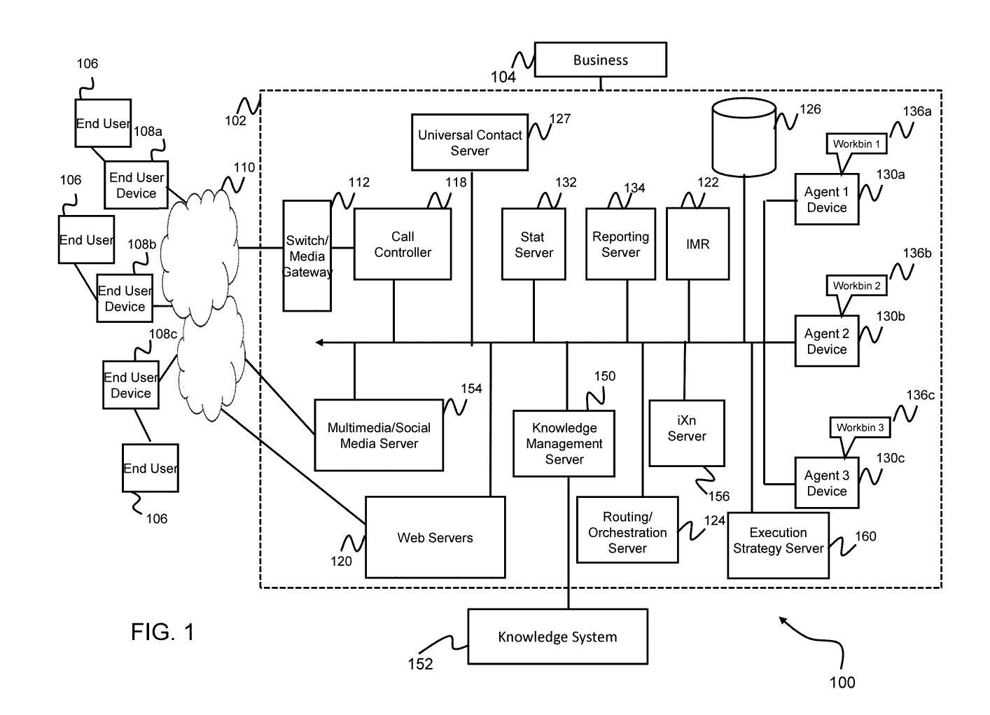

FIG. 1 is a block diagram of a system (hereinafter referred to as a contact center system 100) for anticipating and preloading data and anticipating user interactions in a customer contact center, according to some embodiments of the present invention. In some embodiments, the contact center system 100 may operate as part of a contact center 102. The contact center 102 may be an in-house facility to a business or enterprise (or, according to some embodiments, a plurality of businesses or enterprises operating, for example, in collaboration with one another) 104 for serving the enterprise in performing the functions of sales and service relative to the products and services available through the enterprise. In another aspect, the contact center 102 may be operated by a third-party service provider. According to another embodiment, the contact center 102 may operate as a hybrid system in which some components of the contact center 102 are hosted at the contact center premise and other components are hosted remotely (e.g., in a cloud-based environment). The contact center 102 may be deployed in equipment dedicated to the enterprise or third-party service provider, and/or deployed in a remote computing environment such as, for example, a private or public cloud environment with infrastructure for supporting multiple contact centers for multiple enterprises. The various components of the contact center may also be distributed across various geographic locations and computing environments and not necessarily contained in a single location, computing environment, or even computing device.

According to one example embodiment, the contact center 102 includes resources (e.g. personnel, computers, and telecommunication equipment) to enable delivery of services via telephone or other communication mechanisms. Such services may vary depending on the type of contact center, and may range from customer service to help desk, emergency response, telemarketing, order taking, and the like.

Customers, potential customers, or other end users (collectively referred to as customers or end users, e.g., end user 106) desiring to receive services from the contact center 102 or the business 104 may initiate an inbound communication to the contact center 102 via their end user devices 108a-108c (collectively referenced as electronic device 108).

Each of the electronic devices 108 may be a communication device conventional in the art, such as, for example, a telephone, wireless phone, smart phone, personal computer, electronic tablet, and/or the like, that is configured to engage in communications with other electronic devices. Users operating the electronic devices 108 may initiate, manage, and respond to telephone calls, emails, chats, text messaging, web-browsing sessions, and other multi-media transactions.

Inbound and outbound communications from and to the electronic devices 108 may traverse the telephone, cellular, and/or data communication network 110 depending on the type of device that is being used. For example, the communications network 110 may include a private or public switched telephone network (PSTN), local area network (LAN), private wide area network (WAN), and/or public wide area network such as, for example, the Internet. The communications network 110 may also include a wireless carrier network including a code division multiple access (CDMA) network, global system for mobile communications (GSM) network, and/or any 3G or 4G network conventional in the art.

According to one example embodiment, the contact center 102 includes a switch/media gateway 112 coupled to the communications network 110 for receiving and transmitting telephony interactions between end users and the contact center 102. The switch/media gateway 112 may include a telephony switch or communication switch configured to function as a central switch for agent level routing within the center. The switch may be a hardware switching system or a soft switch implemented via software. In this regard, the switch 112 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, an agent telephony device. In this example, the switch/media gateway establishes a voice path/connection (not shown) between the calling customer and the agent telephony device, by establishing, for example, a connection between the customer's telephony device and the agent telephony device.

According to one example embodiment of the invention, the switch is coupled to a call controller 118 which may, for example, serve as an adapter or interface between the switch and the remainder of the routing, monitoring, and other communication-handling components of the contact center.

The call controller 118 may be configured to process PSTN calls, VoIP calls, and the like. For example, the call controller 118 may be configured with computer-telephony integration (CTI) software for interfacing with the switch/media gateway and contact center equipment. In one embodiment, the call controller 118 may include a session initiation protocol (SIP) server for processing SIP calls. According to some example embodiments, the call controller 118 may, for example, extract data about the customer interaction such as the caller's telephone number, often known as the automatic number identification (ANI) number, or the customer's internet protocol (IP) address, or email address, and communicate with other CC components in processing the interaction.

According to one example embodiment of the invention, the system further includes an interactive media response (IMR) server 122, which may also be referred to as a self-help system, virtual assistant, or the like. The IMR server 122 may be similar to an interactive voice response (IVR) server, except that the IMR server 122 is not restricted to voice, but may cover a variety of media channels including voice. Taking voice as an example, however, the IMR server may be configured with an IMR script for querying customers on their needs. For example, a contact center for a bank may tell customers, via the IMR script, to “press 1” if they wish to get an account balance. If this is the case, through continued interaction with the IMR server 122, customers may complete service without needing to speak with an agent. The IMR server 122 may also ask an open ended question such as, for example, “How can I help you?” and the customer may speak or otherwise enter a reason for contacting the contact center. The customer's response may then be used by a routing server 124 to route the call or communication to an appropriate contact center system 102 resource.

If the communication is to be routed to an agent, the call controller 118 interacts with the routing server (also referred to as an orchestration server) 124 to find an appropriate agent for processing the interaction. The selection of an appropriate agent for routing an inbound interaction may be based, for example, on a routing strategy employed by the routing server 124, and further based on information about agent availability, skills, and other routing parameters provided, for example, by a statistics server 132. The processing logic of the routing/orchestration server 124 may be rules driven, and may leverage, for example, intelligent workload distribution protocols and various business rules for routing the interactions.

In some embodiments, the routing server 124 may query a customer database, which stores information about existing clients, such as contact information, service level agreement (SLA) requirements, nature of previous customer contacts and actions taken by contact center to resolve any customer issues, and the like. The database may be managed by any database management system conventional in the art, such as Oracle, IBM DB2, Microsoft SQL server, Microsoft Access, PostgreSQL, MySQL, FoxPro, NoSQL, SQLite, and the like, and may be stored in a mass storage device 126. The routing server 124 may query the customer information from the customer database via an ANI or any other information collected by the IMR 122.

Once an appropriate agent is identified as being available to handle a communication, a connection may be made between the customer and an agent device 130a-130c (collectively referenced as 130) of the identified agent. Collected information about the customer and/or the customer's historical information may also be provided to the agent device for aiding the agent in better servicing the communication. In this regard, each agent device 130 may include a telephone adapted for regular telephone calls, VoIP calls, and the like. The agent device 130 may also include a computer for communicating with one or more servers of the contact center and performing data processing associated with contact center operations, and for interfacing with customers via voice and other multimedia communication mechanisms.

The contact center system may also include a multimedia/social media server 154 for engaging in media interactions other than voice interactions with the end user devices 108. The media interactions may be related, for example, to email, vmail (voice mail through email), chat, video, text-messaging, web, social media, co-browsing, and the like. In this regard, the multimedia/social media server 154 may take the form of any IP router conventional in the art with specialized hardware and software for receiving, processing, and forwarding multi-media events. According to some embodiments, the multimedia/social media server 154 may be configured to maintain chat conversations, generate chat transcripts, and determine whether or not a chat communication is completed (e.g., based on timeout or by a customer closing a chat window). Additionally, the multimedia/social media server 154 may be configured to keep a chat session alive even when a particular chat server instance crashes, and also process or facilitate chat transfers and conference sessions.

The web servers 120 may include, for example, social interaction site hosts for a variety of known social interaction sites to which an end user may subscribe, such as, for example, Facebook, Twitter, and the like. In this regard, although in the embodiment of FIG. 1 the web servers 120 are depicted as being part of the contact center system 102, the web servers may also be provided by third parties and/or be maintained outside of the contact center. The web servers may also provide web pages for the enterprise that is being supported by the contact center. End users may browse the web pages and get information about the enterprise's products and services. The web pages may also provide a mechanism for contacting the contact center, via, for example, web chat, voice call, email, web real time communication (WebRTC), or the like.

According to one example embodiment of the invention, in addition to real-time interactions, deferrable (also referred to as back-office or offline) interactions/activities may also be routed to the contact center agents. Such deferrable activities may include, for example, responding to emails, responding to letters, attending training seminars, or any other activity that does not entail real time communication with a customer. In this regard, an interaction (iXn) server 156 interacts with the routing server 124 for selecting an appropriate agent to handle the activity. Once assigned to an agent, an activity may be pushed to the agent, or may appear in the agent's workbin 136a-136c (collectively referenced as 136) as a task to be completed by the agent. The agent's workbin may be implemented via any data structure conventional in the art, such as, for example, a linked list, array, and/or the like. The workbin 136 may be maintained, for example, in buffer memory of each agent device 130.

According to one example embodiment of the invention, the mass storage device(s) 126 may store one or more databases relating to agent data (e.g. agent profiles, schedules, etc.), customer data (e.g. customer profiles), interaction data (e.g. details of each interaction with a customer, including reason for the interaction, disposition data, time on hold, handle time, etc.), and the like.

According to one embodiment, some of the data (e.g. customer profile data) may be maintained in a customer relations management (CRM) database hosted in the mass storage device 126 or elsewhere. The mass storage device may take form of a hard disk or disk array, flash memory, magnetic table, or other suitable mass storage device as is conventional in the art, for storing information used as part of the contact center system 100 and the contact center system 100.

According to some embodiments, the contact center system 102 may include a universal contact server (UCS) 127, configured to retrieve information stored in the CRM database and direct information to be stored in the CRM database. For example, the UCS 127 may be utilized as part of the contact center system 100 to facilitate maintaining a history on how well a particular contact center resource, tool, agent, etc., functions for a given customer or interaction topic as a reference for interactions. The UCS 127 may also be configured to facilitate maintaining a history of customers' preferences. Additionally, the UCS 127 may be configured to capture and store data regarding comments from agents, customer communication history, and the like.

The contact center system 100 may additionally include a knowledge management server 150 for facilitating interactions between customers operating the end user devices 108a-108c and a knowledge system 152 (which may be included as part of the contact center 102, or may be operated remotely by a third party). The knowledge management server 152 is a computer system capable of receiving questions and providing answers as output. According to some example embodiments, the knowledge system may be embodied as IBM Watson®. Of course, any other knowledge system may be used as will be appreciated by a person having ordinary skill in the art. In some embodiments, the knowledge system 152 is an artificially intelligent computer system capable of answering questions posed in natural language by retrieving information from information sources such as encyclopedias, dictionaries, newswire articles, literary works, or other documents submitted to the knowledge system 152 as reference materials, as is well known in the art.

Referring again to the routing/orchestration server 124, this server is configured to work with the various other components of the contact center system 100 for orchestrating the handling of interactions based on a routing strategy utilized by the particular contact center. Depending on the type of routing strategy (flow) generated for a particular route point of the contact center (e.g. a particular dialed number), and depending on the specific values of parameters set for the routing strategy, different options, media treatments, and routing is performed for the interaction. The routing may involve invoking different media channels as determined by the generated flow. For example, the flow may call for multi-modal interaction where two or more media channels are invoked in parallel. In this regard, the orchestration server 124 is configured to transmit message (e.g. SIP messages) to different servers including a SIP server, chat server, email server, and the like, depending on the type of media channel that is invoked.

The contact center system 100 may also include a reporting server 134 configured to generate reports from data aggregated by the statistics server 132. Such reports may include near real-time reports or historical reports concerning the state of resources, such as, for example, average waiting time, abandonment rate, agent occupancy, and the like. The reports may be generated automatically or in response to specific requests from a requestor (e.g. agent/administrator, contact center application, and/or the like).

According to some embodiments of the present invention, the contact center system may further include an execution strategy server 160 for managing automated communications with end users 106 operating end user devices 108 to determine customer intent and generate an execution plan based on the customer intent. According to one embodiment, the execution strategy server 160 may be in electronic communication with the other resources of the contact center system 100. For example, the execution strategy server 160 may be coupled to the interaction server 156, statistics server 132, knowledge management server 150, and orchestration server 124 for generating and executing an execution strategy.

Throughout the present Specification, the terms “execution strategy,” “execution flow,” “execution path,” and “execution plan” are used interchangeably to refer to a flow of steps executed as part of a communication session between components or resources of a contact center system and a customer operating a customer communication device.

Although the execution strategy server 160 is depicted in the embodiment of FIG. 1 as being a separate server component, a person of skill in the art should recognize that the functionalities of the execution strategy server 160, described in more detail below, may be incorporated into and/or performed by any other suitable contact center resource operating as part of the contact center system 100. For example, according to some embodiments, the functionalities of the execution strategy server 160 may be incorporated into and/or performed by the IMR 122 and/or the orchestration server 124.

The various servers of FIG. 1 may each include one or more processors executing computer program instructions and interacting with other system components for performing the various functionalities described herein. The computer program instructions are stored in a memory implemented using a standard memory device, such as, for example, a random access memory (RAM). The computer program instructions may also be stored in other non-transitory computer readable media such as, for example, a CD-ROM, flash drive, or the like. Also, although the functionality of each of the servers is described as being provided by the particular server, a person of skill in the art should recognize that the functionality of various servers may be combined or integrated into a single server, or the functionality of a particular server may be distributed across one or more other servers without departing from the scope of the embodiments of the present invention.

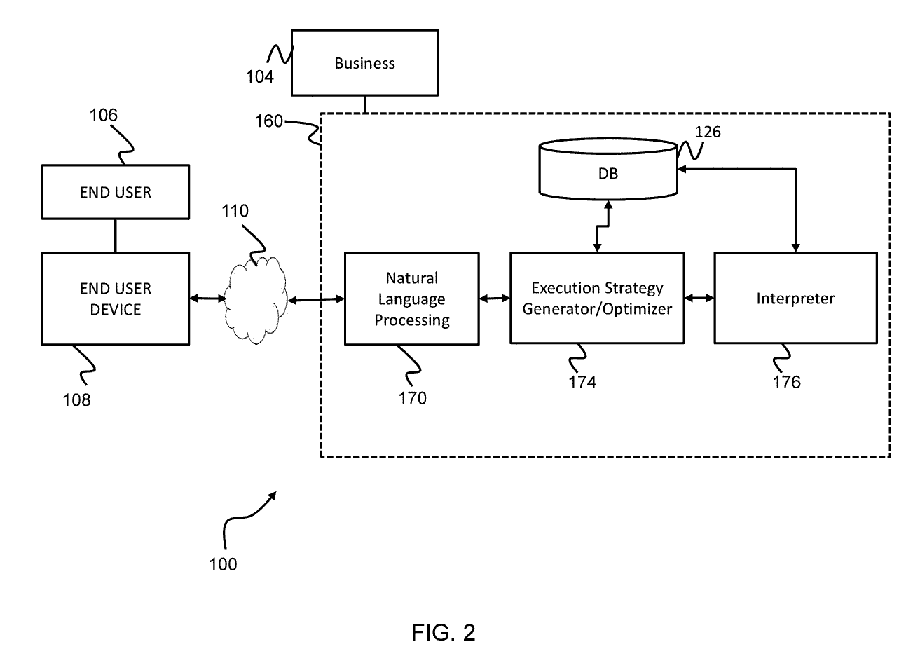

FIG. 2 is a more detailed schematic block diagram of the execution strategy server 160 operating as part of the contact center system 100, according to some embodiments of the present invention. During a communication session between the contact center 102 and an end user 106, the execution strategy server 160 is coupled to (e.g., in electronic communication with) the end user device 108 operated by the customer 106 over the data communications network 110. As discussed above, the execution strategy server 160 may be operated by the business 104 (or a plurality of businesses 104 operating collaboratively) for engaging in communication sessions with customers. According to embodiments of the present invention, the execution strategy server 160 may operate to enable customers to provide natural language input, for example, to provide customer data and establish the customer's intent for a communication session, thereby avoiding inefficiencies associated with related art IVR systems. Additionally, the execution strategy server 160 may operate to dynamically generate an execution strategy or execution flow after receiving the customer's natural language input, thereby reducing instances in which the customer is limited to following one of a finite number of predefined or predetermined communication paths. By dynamically generating an execution strategy or execution flow after receiving the customer's input, the contact center system 100 may be enabled to optimize the execution flow, avoid repetitive steps in the execution flow, and/or perform multiple steps in the execution flow simultaneously instead of sequentially, as will be discussed in more detail below.

According to some example embodiments, the execution strategy server 160 may be configured with a natural language processing module or engine 170 for facilitating or coordinating natural language communications between the customer 106 and the contact center system. According to some example embodiments, the natural language processing module 170 may operate to receive the customer's user input or signals from the end user device 108 during a communication session, for example, after minimal prompting to the user. For example, the execution strategy server 160 (or any other suitable component of the contact center system 100, such as the IMR 122) may transmit a signal or automated voice communication to the customer 106 through the end user device 108 asking the customer to describe their objective (e.g., “how may I help you today?”).

The natural language processing module 170 may then parse the user's input using any suitable natural language processing (NLP) algorithm or strategy to identify various parts of speech and parameters of the customer's objective. The user input may be free speech or text (e.g., natural language speech or text). In the example where the user input is free speech, the module 170 may process the speech to find key phrases, and the key phrases may be matched with speech recognition grammar to identify on or more pre-stored categories of user intent/objective. Thus, embodiments of the present invention enable customers (e.g., users) to provide customer input in the form of natural language or free speech or text to the contact center system. The customer input may include various personal information, customer history data, and the like, as well as an objective or even a plurality of objectives, each of which can be parsed and identified by the contact center system. Accordingly, embodiments of the present invention may enable customers to avoid traversing numerous steps in an interactive voice response menu, for example, to more quickly and more conveniently provide information to the contact center system. Additionally, the contact center system is enabled, as will be described in more detail below, to obtain multiple customer objectives quickly and prior to generating an execution strategy, which may facilitate more efficient use of resources and lower costs to the contact center, as well as increased time efficiency for both the customer and the contact center. Furthermore, as described in more detail below, embodiments of the present invention may utilize a hybrid system with free speech or natural language speech or text and predefined or preprogrammed steps for achieving IMR building blocks for facilitating specific scenarios and conversations or objectives. For example, a certain type of service or conversation objective may utilize certain user data. Accordingly, embodiments of the present invention may a predefined or preprogrammed IMR building block for collecting the relevant user data. User data that is already known, for example, from initial free speech user input or archived customer profile data could be prepopulated, and the IMR building block may collect only the remaining data. Additionally, embodiments of the present invention are configured to generate additional predefined IMR building blocks for collecting relevant data or information from users based on analyzing previous conversations and one or more business needs. An execution strategy generator and/or optimizer 174 may also be included as part of the execution strategy server 160. Based on the parameters of the customer's one or more objectives, the execution strategy generator 174 may operate to generate and/or optimize an execution strategy or execution flow for achieving the customer's one or more objectives. According to some example embodiments, the execution strategy generator 174 is configured to identify the user's one or more objectives based on the natural language processing, and dynamically generate an execution plan or execution flow to achieve the one or more objectives.

According to some embodiments, during an initial free speech conversation the system may identify multiple corresponding services or conversation objectives to be achieved. The execution strategy generator 174 may identify dependencies between the services or conversation objectives, for example, a first service or objective should be performed prior to a second service or objective, whereas a third service or objective is independent of the first two services or objectives and can be processed in parallel. Additionally, according to embodiments of the present invention, the execution strategy generator 174 may identify a best matching media type for a given service or conversation objective and generate an execution strategy according to the matching media type, which may also be influenced or dependent upon a user's preferences.

According to some embodiments, a plurality of predefined or predetermined objectives or actions that the contact center system 100 is configured to handle are stored in memory, for example, in the database 126. For any given customer objective, the execution strategy generator 174 may identify or retrieve (e.g., from memory 126) one or more intermediate steps or actions to occur for achieving the objective. For example, achieving an objective may involve various intermediate steps for obtaining additional information from the customer such as personal identifying information or authentication information, purchase history information, personal preferences about various products or services, and the like. Additionally, achieving an objective may involve various intermediate steps for obtaining additional information from other contact center resources (e.g., the memory 126, stat server 132, etc.) as well as external or third party resources (e.g., third party clouds, knowledge system 152, etc.).

The intermediate steps for achieving the objective may be represented and pre-stored in memory (e.g., memory 126) in association with the objective and generated using any suitable language or framework conventional in the art, such as, for example, Artificial Intelligence Markup Language (AIML), SCXML, or the like.

By identifying the intermediate steps necessary to achieve a customer's objective, the execution strategy generator 174 then operates to generate an execution strategy or flow by organizing the steps into an appropriate order based on a logical progression of steps. For example, for any given customer objective, certain steps must occur before other steps, while the order of some steps may vary depending on different execution path variations. The execution strategy may be generated using any of various languages and frameworks conventional in the art such as, for example, AIML, SCXML, or the like, to interconnect the intermediate steps according to the design of the execution strategy.

According to some embodiments, based on the intermediate steps identified for achieving the customer's objective, the execution strategy generator 174 may obtain analytics or status information regarding various contact center resources, and optimize the execution flow (e.g., generate an optimized execution flow) in order to reduce latency between steps, or to optimize demands on contact center resources. According to some embodiments, optimizing the execution flow may include consolidating redundant steps (e.g., steps that are utilized to achieve multiple objectives, such as customer identification or authentication) and/or utilizing any suitable shortest path algorithm, for example, Direct A-Cyclic Graph with positive weights, to identify an optimized execution path from one or more possible variations of execution paths. An optimized execution path may include, for example, a path in which certain steps are performed in parallel rather than serially, thereby reducing overall latency for achieving the customer's objective. An optimized execution path may also include, for example, a path in which the order of certain steps varies from that of other possible execution paths, in order to reduce the burden on certain contact center resources at certain times.

An optimized execution path in the context of a scheduled callback may include, for example, offering timeslots when an expert agent for multiple services or conversation objectives will be available. In the context of a customer wishing to achieve various objectives in which overlapping personal data would be collected to achieve each individual objective, an optimized execution path may include collecting all of the relevant personal data a single time and utilized when needed for the different conversation objectives.

In some embodiments, an optimized execution flow may include processing multiple conversation objectives in parallel, for example, by way of different media channels. Further, in situations in which multiple users request the same or similar knowledge or expert information, the requests may be aggregated into one request and the response may be distributed to each of the customers (e.g., by way of a chat or text-based communication channel).

According to some embodiments, an optimized execution flow may involve arranging or ordering the steps for achieving a particular conversation objective, for example, based on previous communication history, user preferences, agent availability, cross-/up-sell potential offerings, and the like.

Additionally, an optimized execution flow may be configured to have reduced cost with respect to contact-center resources, for example, by selecting sufficiently qualified agents that are paid less than other agents, or by avoiding the use of expensive system or hardware resources if the objective can be achieved through less expensive mechanisms (such as through a simple selection menu as opposed to ASR). An optimized execution flow may additionally be designed to resolve customer objectives during a fewer number of interactions (e.g., during the first communication), thereby avoiding repeated calls.

An interpreter module 176 operating as part of the execution strategy server 160 (or incorporated into another component of the contact center system 100 such as, for example, the orchestration server 124) then operates to interpret and execute the execution strategy generated by the execution strategy server 160.

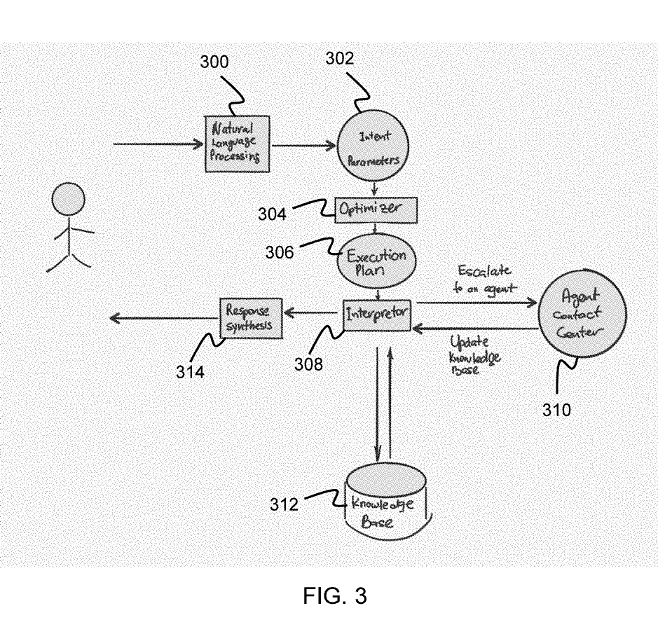

FIG. 3 is a flow diagram of a process for dynamic generation and optimization of process flows, according to some embodiments of the present invention. In general, at 300, at the beginning of a communication session, customer input is received by the execution strategy server 160 at which point natural language processing is performed on the customer input by the NLP module 170. According to some embodiments, a customer may be given minimal prompting, for example, using automated media (e.g., voice or text) requesting that the customer explain one or more reasons or intentions (e.g., objectives) for the communication session.

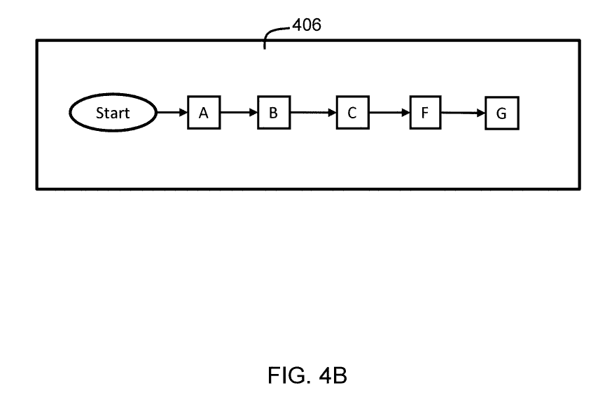

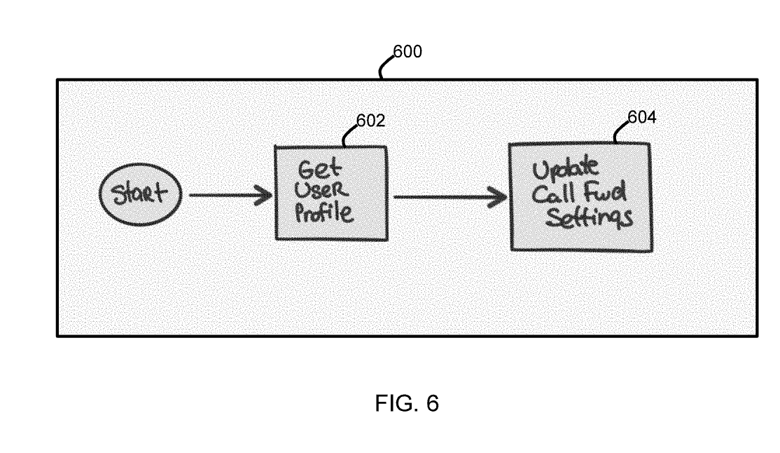

At 302, the NLP module 170 parses intent parameters from the natural language customer input using any suitable natural language processing algorithm. Intent parameters include, for example, subject, verb, objects, and any other relevant details or data provided by the user. For example, if a user provides natural language input saying “I would like to pay my bill,” the NLP module 170 may identify the subject “I,” the verb “pay,” and the object “bill.” As shown, for example, in FIGS. 5 and 7, below, the subject “I” may then be identified as the start node in a domain model graph for generating an execution strategy. Then verb “pay” is identified as a subsequent node, or an edge, in the domain model graph. Additionally, the object “bill” may be identified as a final node in the domain model graph. At 304, the parsed intent parameters are provided to an execution strategy generator and/or optimizer (e.g., execution strategy server 174), which, at 306, generates an execution plan or strategy as discussed above. The execution strategy is provided to an interpreter (e.g., interpreter 176), which proceeds by executing the execution strategy. According to some embodiments, executing the execution strategy may involve escalating a communication to an agent (e.g., at 310) and transmitting information to or retrieving information from other contact center resources (e.g., at 312). At 314, a response or customer message is synthesized and transmitted to the customer device to communicate information to the customer.

According to some embodiments, the different phases illustrated in FIG. 3 may cycle through several iterations in any given communication session. For example, in some instances, because the present invention enables natural language customer input, customers may not always provide enough information to achieve one or more objectives, and additional customer input may be needed or desired in order to continue progressing toward achieving the customer's objective(s). In such instances, at 314, an automated message may be provided to the customer prompting the customer to provide the additional customer input and the system may continue, at 300, to perform natural language processing on the new input and then generate, revise, or continue along an execution plan until the customer's one or more objectives have been achieved.

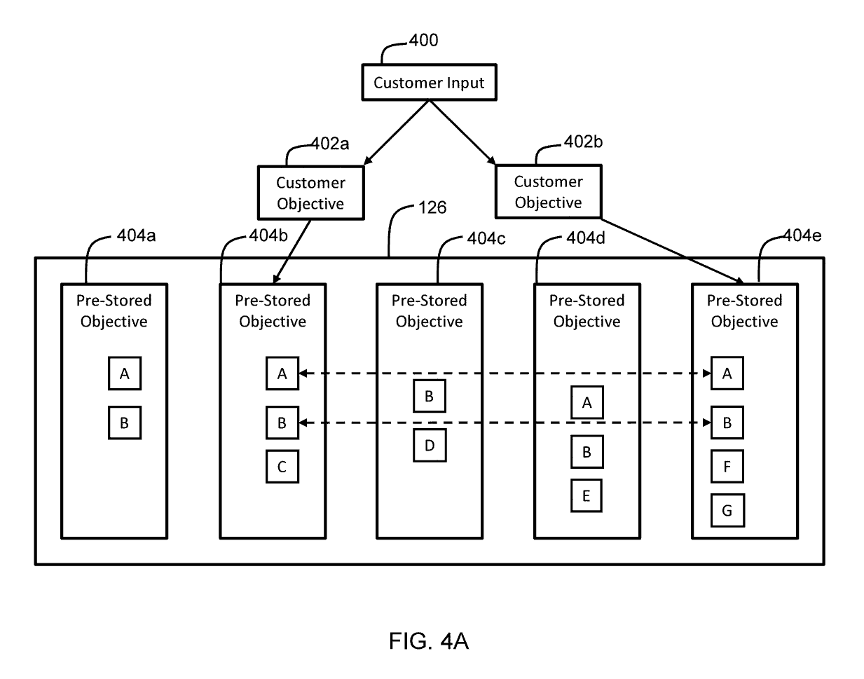

FIGS. 4A and 4B are block diagrams illustrating a process for generating (and/or optimizing) an execution strategy, according to some example embodiments of the present invention. As illustrated in FIG. 4A, a customer provides customer input 400 to the contact center system (e.g., by the natural language processing module 170), and natural language processing is performed on the customer input 400 to parse the customer input 400 and identify one or more customer objectives 402a and 402b. Although the number of customer objectives illustrated in FIG. 4A is two, embodiments of the present invention are not limited thereto. Rather, the number of customer objectives that are identified by the customer contact center system may vary according to the design of the customer contact center system (e.g., depending on the number of pre-stored or preprogrammed customer objectives), as well as the nature of the customer input (e.g., the number of customer objectives included as part of the customer input.

After the one or more customer objectives 402a-402b are identified, the customer contact center system compares (e.g., by the execution strategy generator 174) the identified customer objectives 402a-402b with a plurality of pre-stored or preprogrammed customer objectives 404a-404e stored in memory (e.g., the memory 126). The number of pre-stored or preprogrammed customer objectives is not limited to the number illustrated in FIG. 4A, and may vary according to the design of the customer contact center system. Each pre-stored or preprogrammed customer objective includes, or is associated with one or more intermediate preprogrammed steps A-G for achieving the objective. The number and nature of the preprogrammed steps may vary according to the design of the customer contact center system.

By comparing the customer objectives 402a-402b with the preprogrammed customer objectives 404a-404e, the customer contact center system may identify (e.g., by the execution strategy generator 174) one or more of the preprogrammed customer objectives 404a-404e that matches the customer objectives 402a-402b provided as part of the customer input. For example, in the embodiment illustrated in FIG. 4A, the customer contact center system identifies that the preprogrammed customer objectives 404b and 404e match or correspond to the customer objectives 402a-402b provided as customer input. Additionally, the customer contact center system may further identify overlap or redundancies regarding the intermediate preprogrammed steps associated with the matching preprogrammed customer objectives. For example, in the embodiment illustrated in FIG. 4A, the customer contact center system (e.g., by the execution strategy generator 174) identifies overlap or redundancy between the intermediate preprogrammed steps A and B, which are associated with both of the preprogrammed customer objectives 404a and 404e. The customer contact center system also identifies that the intermediate preprogrammed step C is unique to (e.g., only performed for achieving) the preprogrammed customer objective 404b, and the intermediate preprogrammed steps F and G are unique to the preprogrammed customer objective 404e.

Next, as illustrated in FIG. 4B, the customer contact center system (e.g., by the execution strategy generator 174) generates an execution flow 406 based on the identified customer objectives 402a-402b, and the intermediate preprogrammed steps A, B, C, F, and G associated with the preprogrammed customer objectives 404a and 404e. As illustrated in FIG. 4B, as part of the generation of the execution flow 406, the contact center system may optimize the execution strategy, for example, by consolidating redundant intermediate preprogrammed steps (e.g., A and B) for the customer objectives.

FIG. 5 is a an example domain specific language model graph illustrating an example use case of a dynamic execution strategy system for a pre-paid service cellular provider operating a contact center system according to some embodiments of the present invention. Assume, for the purpose of illustration, that a pre-paid service cellular provider has a customer for which various actions may be taken related to the customer and certain customer objectives may be achieved. Starting at block 500, as illustrated in FIG. 5 therefore, a customer can make a call (502), the history of which can be stored in memory as customer data history (504). Additionally, the customer owns or is associated with a customer account (506), which has corresponding customer provisioning or preference settings (508) and also one or more customer payment methods (510), which are associated with the customer account. During an interaction with the customer, the customer, through the customer account, can achieve an objective of paying a bill (512) using the one or more customer payment methods (510), and such bill payments can be stored in memory as bill payment history (514) and/or consolidated into customer data history 504.

Each of the blocks or nodes 500 through 514 represent various possible nodes or operations in an execution strategy, some of which have relationships or connections with other nodes as illustrated by the arrows. An execution strategy may be generated based on customer input, which may be parsed using natural language processing to identify intent parameters, thereby enabling the system to identify a starting node, an ending node, and intermediate nodes. The system may then generate an execution strategy that follows a path from the starting node to the ending node and passes through the intermediate nodes. In certain situations, various possible execution strategies may be possible, and the system may optimize the execution strategy, for example, by selecting the path passing through the fewest number of nodes, the path having the lowest cost, or by consolidating redundant nodes or aspects of redundant nodes.

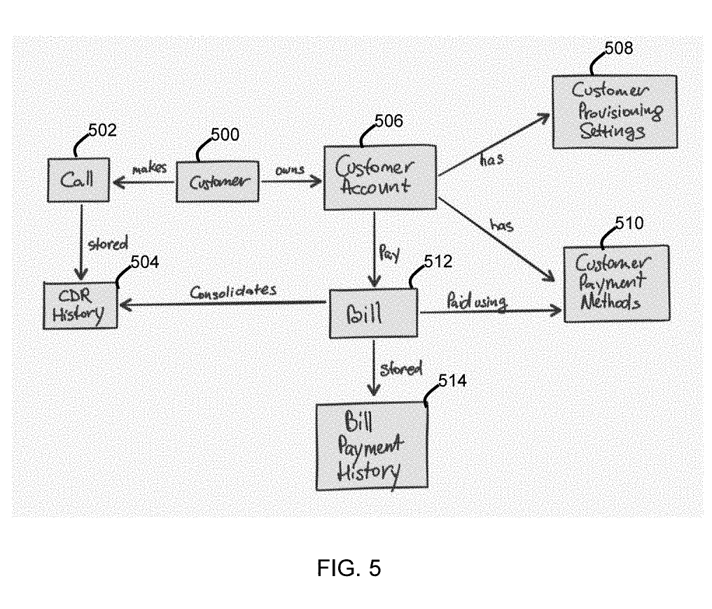

FIG. 6 illustrates an example execution plan for a self-provisioning operation as part of a contact center system, according to some example embodiments of the present invention. Each block or step of an execution plan corresponds to code or instructions (generated, for example, using any suitable domain specific language, as discussed above) for executing the step. Code for executing the step is pre-stored in association with objectives, as discussed above. In particular, assume for the purposes of illustration that a customer engaging in a communication session with the contact center system 100 and the execution strategy server 160 wishes to achieve the objective of forwarding all telephone calls related to their account to another telephone number. The customer provides natural language or unstructured customer input, saying “forward my calls to 415xxxxxxx.” Referring to FIGS. 2 and 3 in the context of the example of FIG. 4, a natural language processing operation is performed on the customer input, and the query may be parsed or interpreted into the following components or parameters:

Update: customer_provisioning_settings, where userid==“identified user” set call_forward=“415xxxxxxx.”

Thus, the objective may be identified as the customer wishing to update the customer provision or preference settings. Additionally, unique identification data may be used to identify the user (e.g., by way of the phone number from which the customer is calling). Finally, the new setting for call forwarding is to be set to “415xxxxxxx.”

In order to parse the natural language sentence of the customer input as described above, the natural language engine may first identify various parts of speech such as the verb “forward,” the noun “calls,” and the contextual string of characters “414xxxxxxx.” The word forward may be a pre-stored or predefined synonym for the action of updating call forward settings. Accordingly, the system may interpret the sentence as follows: ‘forward’=>“update<user preferences>set call forwarding=<context>” according to the existing knowledge of the system. Because the certain data may be unknown, such as “user preferences,” the system may prompt the user to provide such information or retrieve the information from memory, and then insert the information into the rule.

As illustrated in FIG. 6, the execution plan 600 for updating call forwarding settings, entails identifying the data to be retrieved and/or updated in order to achieve the objective, including executing various steps 602 (e.g., retrieving the user profile) and 504 (e.g., updating call forwarding settings) in the form of an execution strategy to achieve that objective. As discussed above, the steps 602 and 604 for achieving the objective 600 may be pre-stored in memory and retrieved upon identification of the objective 600 during the natural language processing operation.

In the use case illustrated in FIG. 6, the generation of the execution flow or execution strategy may be relatively simple, because there are no other objectives to be achieved in the same communication session, and the step 604 (updating call forwarding settings) logically must follow set 602 (retrieving the user profile), because an alternative order of the steps would not function logically. In other words, a user's call forwarding settings cannot be updated until their user profile is first retrieved.

FIG. 7 illustrates a more complicated use case. In particular, FIG. 7 is an execution plan 700 for handling a bill payment inquiry, according to some example embodiments of the present invention. Assume for the purposes of illustration that following receipt of customer input and a natural language processing operation, the execution strategy server 160 identifies the customer objective is to pay the most recent bill based on the customer natural language input “pay my last bill.”

According to the use case of FIG. 7, the system generates an execution strategy following the same or similar process described above, after receiving the customer input indicating the customer's objective. A plurality of pre-stored or preprogrammed steps 702 through 710 are associated with and retrieved for achieving the customer objective 700. However, in generating the execution strategy, the execution strategy server 160 identifies or detects that two of the steps, 704 (retrieving the last bill amount) and 706 (retrieving the default payment method) are pre-requisites of the step 708 (pay the bill), but that the steps are also independent of one another. In other words, the steps 704 and 706 can be executed in parallel instead of serially, thereby potentially reducing the time and cost for executing the overall execution strategy.

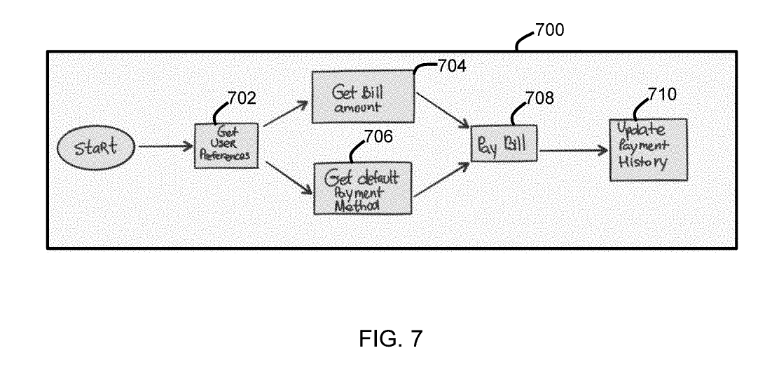

According to some embodiments, the execution strategy server 160 may utilize contact center system analytics and perform an analysis of the next best action, based on customer input. For example, FIG. 8 is an execution plan 800 for handling a service upgrade, according to some example embodiments of the present invention.

For the purposes of illustration, assume a customer for a customer contact center system 100 operating on behalf of a telecommunications provider provides the natural language customer input “My internet is slow—please upgrade it to a faster plan.” Using a natural language processing algorithm, the system may identify the customer objective therefore as being a desire to upgrade service. In response to the customer input, the execution strategy server 160 may initiate retrieval of analytics data regarding the customer contact center system 100 to determine possible options for the alternative Internet plan selection. In particular, the execution strategy server 160 may inquire which Internet plans are available given the customer's location, and then identify which plans are available that are faster than the current package the customer owns. Additionally, an analysis may be performed to select the appropriate shipping method for the customer based on shipment duration and cost. According to some embodiments, the contact center system may be configured to operate as an intermediary between multiple systems. For example, the contact center system may be configured to execute a transaction or achieve an objective with a third party cloud system (e.g., by utilizing a publicly accessible application program interface (API)) to place orders of products or services. In the embodiment illustrated in FIG. 8, for example, the execution strategy 800 includes a step 802 for selecting a shipping provider for shipping a new router, which may be executed by accessing the publicly accessible API of the cloud-based system of the third-party shipment provider. Thus, embodiments of the present invention may enable collaboration with third party systems, for example, by enabling an execution strategy to be generated in which a user may interface with a third party system to achieve a sub-objective. In the context of the example illustrated in FIG. 8, for example, when selecting a shipment method, a user may be prompted or provided an interface for accessing and reviewing attributes of shipments from a third party, such as shipping price, delivery time, delivery rates, and the like. Additionally, according to some embodiments, the system may enable tracking previous interactions with the third party interface, and providing recommendations to users (e.g., with regard to which third party vendors to use, or which third party products or services to purchase) to improve the customer experience.

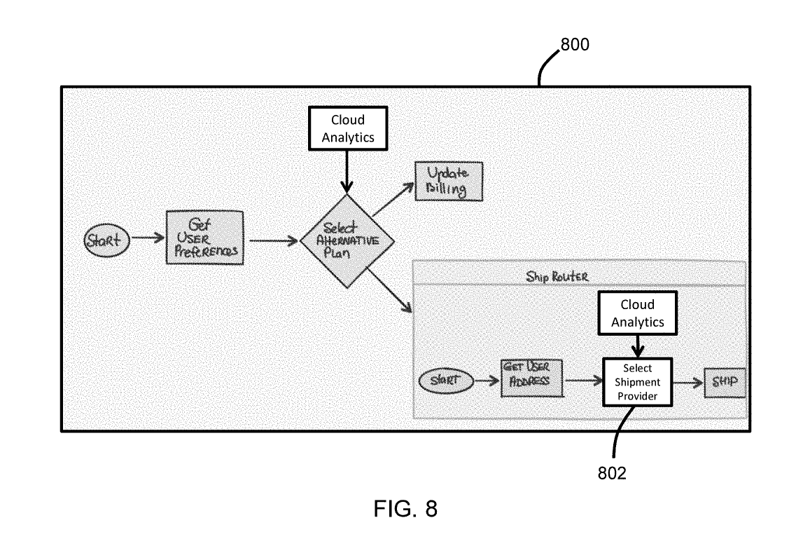

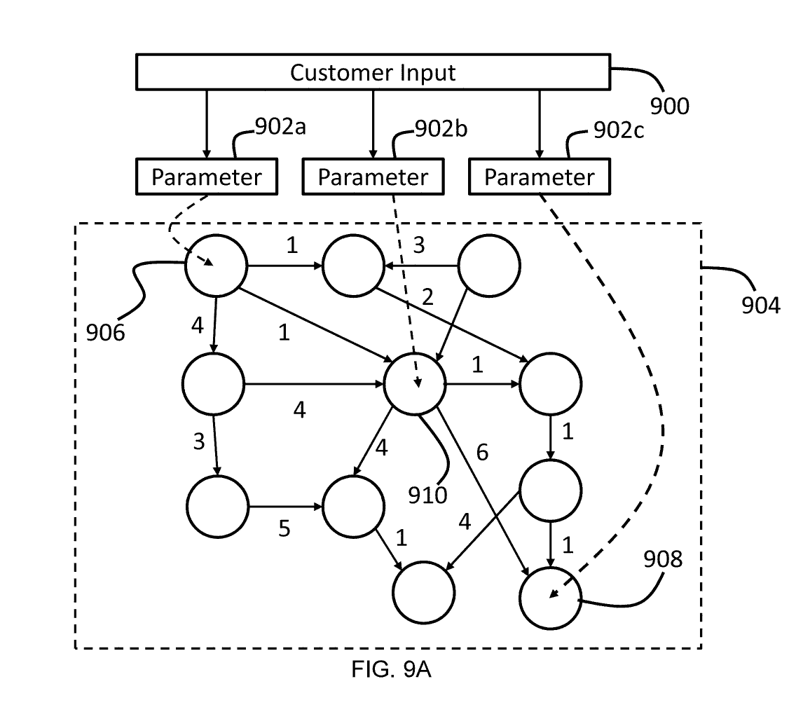

Continuing from FIGS. 1-8, FIG. 9A illustrates a process for mapping intent parameters to a domain model graph for generating an execution strategy, according to some embodiments of the present invention. As illustrated in FIG. 9A, according to some embodiments, customer input 900 (e.g., natural language customer input) is received by the system and parsed into a plurality of intent parameters 902a-902c, as discussed above with respect to FIG. 3 (the number of intent parameters is not limited to the number illustrated in FIG. 9A, and may vary according to the customer input and the design of the system). As discussed above, the intent parameters 902a-902c are identified based on various parts of speech, such as a subject, object, and verb for identifying a starting node or action in an execution flow, a final node, and one or more additional intermediate nodes. The intent parameters 902a-902c may additionally include customer information and additional data relevant to achieving one or more customer objectives.

As discussed above with respect to FIG. 5, the domain model graph 904 corresponds to a contact center system or a business or enterprise supported by a contact center system. Various nodes in the domain model graph correspond to aspects of the business and/or actions that may be executed by the contact center system in support of the business. For example, nodes may include customers of a business, employees of the business, products or services offered by the business, and various actions or activities that may be executed to facilitate transactions or activities between customers and the business. Each node in a domain model graph may include preprogrammed modules or applications for executing various steps for achieving a customer objective. Additionally, each node may be associated with or connected to one or more other nodes (as represented in FIG. 9A by the arrows between the various nodes). Each connection between the nodes may also have an associated cost for transitioning between nodes (as represented by the numbers next to the arrows connecting the various nodes). The particular nodes in a given domain model graph may be established, for example, by interviewing businesses and customers of businesses to identify activities that occur as part of various interactions between customers and contact center systems. Additionally, the cost for navigating between various nodes may vary depending on the nature of the actions occurring at each node. For example, various activities may involve utilizing various contact center resources such as contact center hardware, network bandwidth, agent time, and the like. Such costs may vary depending on the activities that have already occurred (e.g., the connected nodes prior to a given node), for example, because certain aspects of an activity may have already been performed as part of an earlier activity. The costs associated with a progression between any two nodes, however, can be measured or quantified (e.g., numerically) using any suitable method, for facilitating generation of an execution strategy according to embodiments of the present invention.

Each of the intent parameters 902a-902c is matched to a corresponding node in a domain model graph 904, including a start node 906, an end node 908, and one or more intermediate nodes 910. Based on the matching of the intent parameters 902a-902c to the various nodes, the system may generate an optimized execution strategy 920, as shown in FIG. 9B, which includes a subset of the nodes of the domain model graph that includes the start node 906, the end node 908, and the one or more intermediate nodes 910. According to some embodiments, the optimized execution strategy 920 may be generated by selecting an execution strategy or path from among a plurality of potential execution strategies. For example, the optimized execution strategy 920 may be a path that has a total cost that is less than other possible paths, or which includes fewer nodes than other possible paths. Additionally, various redundant nodes, or redundant aspects of various nodes may be consolidated.

Thus, embodiments of the present invention are directed to a system for enabling customers to provide natural language input to a contact center system, with minimal prompting by the contact center system, and the contact center system can then dynamically generate an execution strategy for achieving one or more of the customer's objectives. A customer's objective may be determined based on natural language input. In particular, the natural language customer input is parsed into its various components to identify the customer's objective, which is matched to one or more pre-stored or preprogrammed objectives. Each pre-stored or preprogrammed customer objectives has one or more pre-stored or preprogrammed intermediate steps to be executed in order to achieve the objective. Each possible objective capable of being handled by the contact center system, and the steps for achieving those objectives, would be preprogrammed or pre-stored, but the particular order of the steps could vary depending on various factors such as contact center resources and where there are redundancies in achieving multiple objectives. An execution strategy is then generated by stringing together the various steps in a logical order according to these various optimization factors. Finally, the execution strategy is interpreted and executed by the contact center system to achieve the customer's objective.

Accordingly, embodiments of the present invention may operate to increase customer freedom in communicating and achieving customer objectives. Additionally, because customers are given the freedom to articulate their objectives using natural language, customers are also able to also articulate a desire to achieve multiple objectives during the same communication session, thereby enabling the customer contact center to reduce inefficiencies in an execution strategy. For example, for situations in which multiple objectives include the same or similar intermediate steps, such steps may be consolidated to reduce redundancies. Further, steps that are independent from one another may be executed in parallel thereby potentially reducing the overall latency and cost for achieving the customer's objectives.

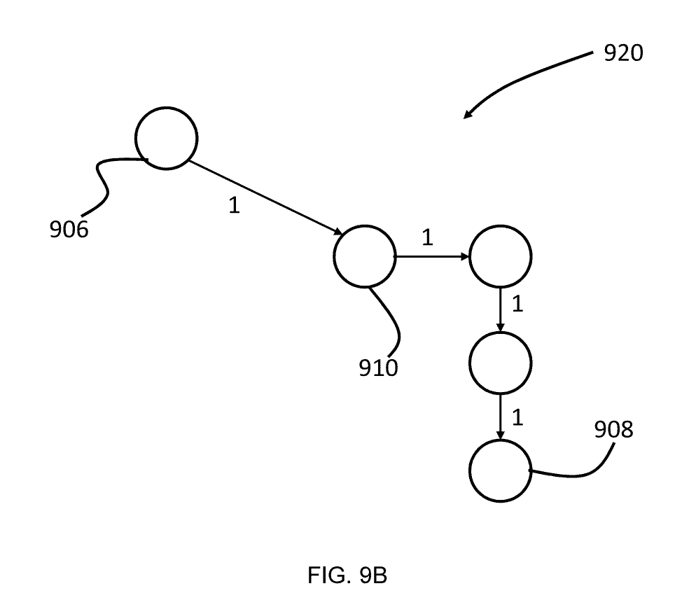

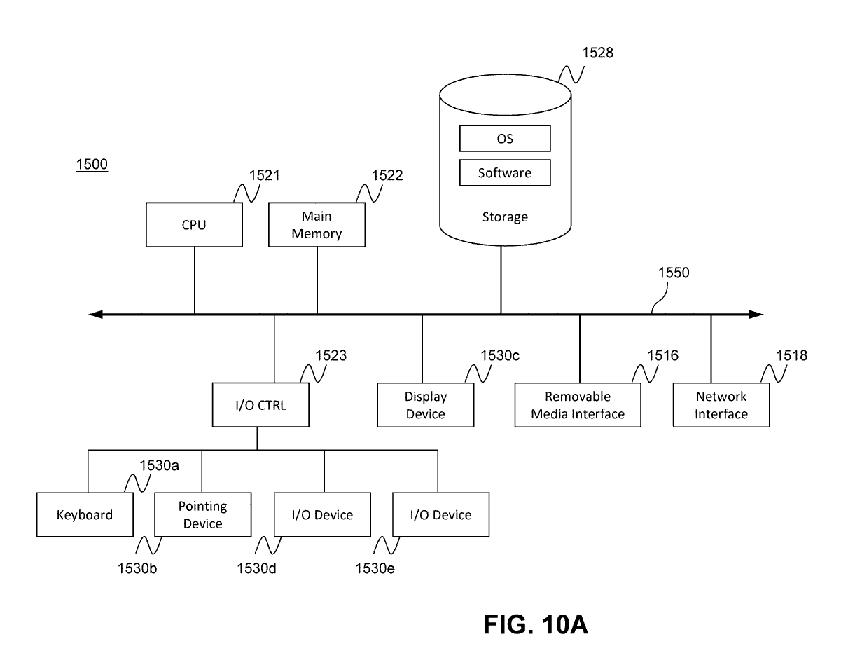

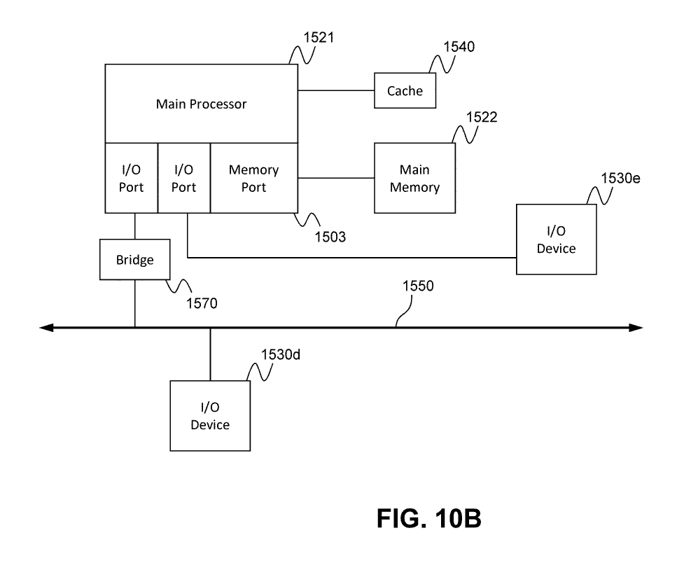

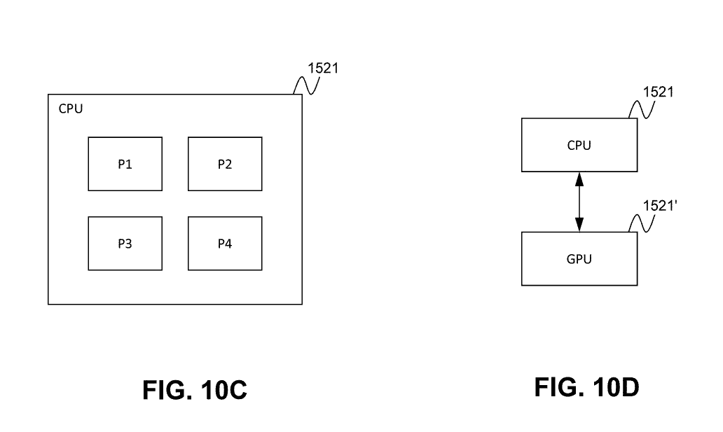

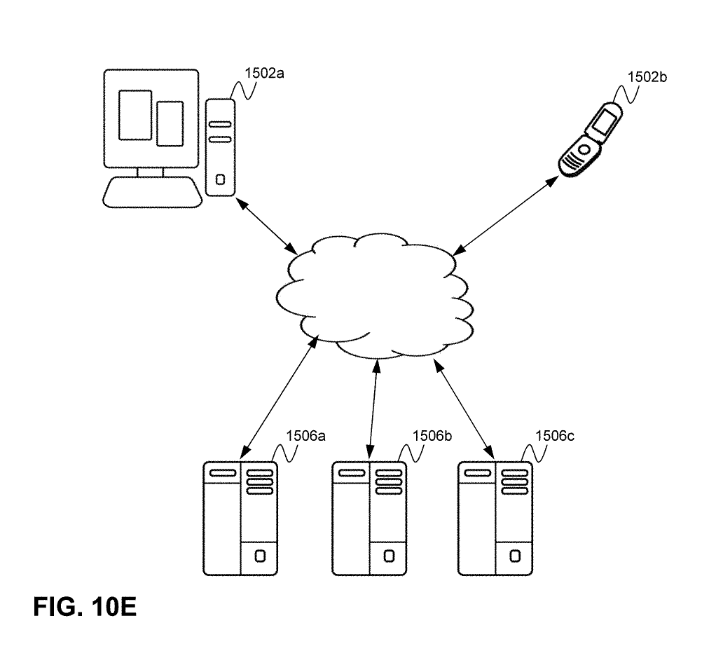

In one embodiment, each of the various servers, controllers, switches, gateways, engines, and/or modules (collectively referred to as servers) in the afore-described figures is a process or thread, running on one or more processors, in one or more computing devices 1500 (e.g., FIG. 10A, FIG. 10B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the example embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments of the present invention, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JavaScript Object notation (JSON).

FIG. 10A and FIG. 10B depict block diagrams of a computing device 1500 as may be employed in example embodiments of the present invention. Each computing device 1500 includes a central processing unit 1521 and a main memory unit 1522. As shown in FIG. 10A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 10B, each computing device 1500 may also include additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 10A, the central processing unit 1521 communicates with the main memory 1522 via a system bus 1550. As shown in FIG. 10B, the central processing unit 1521 may also communicate directly with the main memory 1522 via a memory port 1503.

FIG. 10B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 10A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 10B depicts an embodiment of a computer 1500 in which the central processing unit 1521 communicates directly with I/O device 1530e. FIG. 10B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 10A, may control the I/O devices. The I/O controller may control one or more I/O devices such as a keyboard 1530a and a pointing device 1530b, e.g., a mouse or optical pen.

Referring again to FIG. 10A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further comprise a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may comprise or be connected to multiple display devices 1530c, which each may be of the same or different type and/or form. As such, any of the I/O devices 1530 and/or the I/O controller 1523 may comprise any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect or otherwise use the display devices 1530c. In one embodiment, a video adapter may comprise multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 10A and FIG. 10B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 comprises a combination of devices, such as a mobile phone combined with a digital audio player or portable media player.

As shown in FIG. 10C, the central processing unit 1521 may comprise multiple processors P1, P2, P3, P4, and may provide functionality for simultaneous execution of instructions or for simultaneous execution of one instruction on more than one piece of data. In some embodiments, the computing device 1500 may comprise a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 comprises a multicore microprocessor, which combines two or more independent processors into a single package, e.g., into a single integrated circuit (IC). In one example embodiment, depicted in FIG. 10D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may comprise a plurality of machines so connected. FIG. 10E shows an example network environment. The network environment comprises one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 10E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may comprise a built-in network adapter, such as a network interface card, suitable for interfacing the computing device 1500 to any type of network capable of communication and performing the operations described herein. An I/O device 1530 may be a bridge between the system bus 1550 and an external communication bus.

According to one embodiment, the network environment of FIG. 10E may be a virtual network environment where the various components of the network are virtualized. For example, the various machines 1502 may be virtual machines implemented as a software-based computer running on a physical machine. The virtual machines may share the same operating system. In other embodiments, different operating system may be run on each virtual machine instance. According to one embodiment, a “hypervisor” type of virtualization is implemented where multiple virtual machines run on the same host physical machine, each acting as if it has its own dedicated box. Of course, the virtual machines may also run on different host physical machines.

Other types of virtualization is also contemplated, such as, for example, the network (e.g. via Software Defined Networking (SDN)). Functions, such as functions of the session border controller and other types of functions, may also be virtualized, such as, for example, via Network Functions Virtualization (NFV).

Although this invention has been described in certain specific embodiments, those skilled in the art will have no difficulty devising variations to the described embodiment, which in no way depart from the scope and spirit of the present invention. Furthermore, to those skilled in the various arts, the invention itself herein will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

1. A system for dynamically generating an execution flow for a customer contact center, the system comprising:
a switch;
a processor coupled to the switch; and
a memory coupled to the processor, wherein the memory stores instructions that, when executed by the processor, cause the processor to:
receive customer input related to an ongoing communication session;
perform natural language processing on the customer input to identify a plurality of intent parameters including a plurality of customer objectives;
identify a plurality of execution steps for each of the plurality of customer objectives;
consolidate redundant steps for the plurality of customer objectives to generate consolidated steps;
generate an execution flow for achieving the customer objectives based on the plurality of intent parameters and the consolidated steps; and
transmit a signal to the switch for routing the ongoing communication session to a contact center resource according to the execution flow.

2-4. (canceled)

5. The system of claim 1, wherein the instructions further cause the processor to identify customer profile data based on the customer input.

6. The system of claim 1, wherein the instructions further cause the processor to identify customer interaction history data based on the customer input.

7. The system of claim 1, wherein the instructions further cause the processor to optimize the execution flow according to contact center resources.

8. The system of claim 7, wherein optimizing the execution flow comprises selecting the execution flow from among a plurality of potential execution flows having a cost that is less than other ones of the potential execution flows.

9. The system of claim 7, wherein optimizing the execution flow comprises selecting the execution flow from among a plurality of execution flows based on the execution flow having a number of intermediate operations that is less than that of other ones of the execution flows.

10. The system of claim 1, wherein the instructions further cause the processor to:
retrieve a domain model graph corresponding to the customer contact center, the domain model graph comprising a plurality of interconnected nodes;
match the intent parameters including the customer objectives to corresponding ones of the interconnected nodes; and
generate the execution flow by selecting a path from among a plurality of potential paths for achieving the customer objectives.

11. The system of claim 10, wherein the interconnected nodes correspond to intermediate steps for achieving the customer objectives and comprise preprogrammed modules for executing the intermediate steps.

12. A method for dynamically generating an execution flow for a customer contact center, the method comprising:
receiving, by a processor, customer input related to an ongoing communication session;
performing, by the processor, natural language processing on the customer input to identify a plurality of intent parameters including a plurality of customer objectives;
identifying, by the processor, a plurality of execution steps for each of the plurality of customer objectives;
consolidating, by the processor, redundant steps for the plurality of customer objectives to generate consolidated steps;
generating, by the processor, an execution flow for achieving the customer objectives based on the plurality of intent parameters and the consolidated steps; and
transmitting, by the processor, a signal to a switch for routing the ongoing communication session to a contact center resource according to the execution flow.

13-15. (canceled)

16. The method of claim 12, further comprising identifying, by the processor, customer interaction history data based on the customer input.

17. The method of claim 12, further comprising optimizing, by the processor, the execution flow according to contact center resources.

18. The method of claim 12, wherein optimizing the execution flow comprises selecting the execution flow from among a plurality of potential execution flows having a cost that is less than other ones of the potential execution flows.

19. The method of claim 12, further comprising:
retrieving, by the processor, a domain model graph corresponding to the customer contact center, the domain model graph comprising a plurality of interconnected nodes;
matching, by the processor, the intent parameters including the customer objectives to corresponding ones of the interconnected nodes; and
generating, by the processor, the execution flow by selecting a path from among a plurality of potential paths for achieving the customer objectives.

20. A system for dynamically generating an execution flow for a customer contact center, the system comprising:
means for receiving customer input related to an ongoing communication session;
means for performing natural language processing on the customer input to identify a plurality of intent parameters including a plurality of customer objectives;
means for identifying a plurality of execution steps for each of the plurality of customer objectives;
means for consolidating redundant steps for the plurality of customer objectives to generate consolidated steps;
means for generating an execution flow for achieving the customer objectives based on the plurality of intent parameters and the consolidated steps; and
means for transmitting a signal to a switch for routing the ongoing communication session to a contact center resource according to the execution flow.

21. The system of claim 20, further comprising means for identifying customer profile data based on the customer input.

22. The system of claim 20, further comprising means for identifying customer interaction history data based on the customer input.

23. The system of claim 20, further comprising means for optimize the execution flow according to contact center resources.

24. The system of claim 23, wherein optimizing the execution flow comprises selecting the execution flow from among a plurality of potential execution flows having a cost that is less than other ones of the potential execution flows.

25. The system of claim 23, wherein optimizing the execution flow comprises selecting the execution flow from among a plurality of execution flows based on the execution flow having a number of intermediate operations that is less than that of other ones of the execution flows.

26. The system of claim 20, further comprising:
means for retrieving a domain model graph corresponding to the customer contact center, the domain model graph comprising a plurality of interconnected nodes;
means for matching the intent parameters including the customer objectives to corresponding ones of the interconnected nodes; and
means for generating the execution flow by selecting a path from among a plurality of potential paths for achieving the customer objectives.
